(19) United States
(12) Patent Application Publication
(10) Pub. No.: US 2003/0125942 A1
(43) Pub. Date: Jul. 3, 2003

(54) Speech recognition system with maximum entropy language models

(76) Inventor: Jochen Peters, Aachen (DE)

Correspondence Address: Philips Electronics North America Corporation, Corporate Patent Counsel, 580 White Plains Road, Tarrutown, NY, 10591, US

(21) Appl. No.: 10/257,296

(22) PCT Filed: Mar. 5, 2002
(86) PCT No.: PCT/IB02/00634

(30) Foreign Application Priority Data
Mar. 6, 2001 (DE) 10110608.4

(51) Int. Cl. G10L 15/12

(52) U.S. Cl. 704/236

(57) ABSTRACT

The invention relates to a method of setting a free parameter

$${λ}_{α}^{ortho}$$

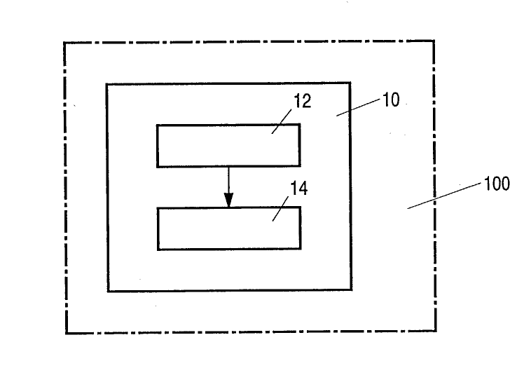

of an attribute in a maximum-entropy speech model, which free parameter could not be set previously with the help of a training algorithm. It is an object of the invention to provide a speech recognition system 100, a training device 10 and a method of setting such a parameter

$${λ}_{α}^{ortho}$$

that has a number of possible interpretations. This object is achieved in accordance with the invention in that

$${λ}_{α}^{ortho}$$

is calculated as follows:

$$\begin{matrix}{λ}_{α}^{ortho} = log ( \frac{{m}_{α}^{ortho , mod}}{{Nenner}_{α}} ) with \\ {m}_{α}^{ortho , mod} = {\sum }_{β ∈ {A}_{i}} {m}_{β}^{ortho} and {denominator}_{α} = {\sum }_{β ∈ Ai} exp ( - {λ}_{β}^{ortho} ) \cdot {M}_{β}^{ortho} .\end{matrix}$$

The invention relates to a method of setting a free parameter

$${λ}_{α}^{ortho}$$

of an attribute α in a maximum-entropy speech model, if this free parameter cannot be set with the help of a training algorithm that has been executed previously.

The invention further relates to a training device and a speech recognition system in which such a method is used.

The starting point for the construction of a conventional speech model, as used in a computer-aided speech recognition system to recognize speech input, is a predefined training task. The training task models certain statistical samples in the speech of a future user of the speech recognition system in a system of mathematically formulated boundary conditions, which in general has the following form:

$${\sum }_{( h , w )} \frac{N ( h )}{N} \cdot {p}_{{λ}^{ortho}} ( w \vert h ) \cdot {f}_{α}^{ortho} ( h , w ) = {m}_{α}^{ortho} \qquad ( 1 )$$

where:

N(h)N: is the relative frequency of the history h in a training corpus;

P_{80 ortho} (w|h): the probability with which a given word w follows a word sequence h (history);

α: a predefined attribute in the speech model;

$${f}_{α}^{ortho} ( h , w )$$

an orthogonalized binary attribute function the attribute α; and

$${m}_{α}^{ortho} :$$

a desired boundary value in the system of boundary conditions.

The superscribed index “ortho” basically designates an orthoganlized value.

The attribute α can, by way of example, designate an individual word, a word sequence, a word class, such as color or verbs, a sequence of word classes or more complex structures.

The orthogonalized binary attribute function

$${f}_{α}^{ortho} ( h , w )$$

makes, by way of example, a binary decision on whether given words are contained at certain positions in given word sequences h, w.

For word-based N-gram attributes α the orthogonalized attribute functions are specifically defined as follows:

$$\begin{matrix}{f}_{α}^{ortho} ( h , w ) = \{ 1 if α fits the word sequence ( h , w ) and \\ \{ is also the attribute with the widest range \\ \{ that fits \\ \{ 0 otherwise\end{matrix}$$

If word and class-based attributes α (or discontinuous-N-grams of different discontinuous structures) are used, then these are accordingly subdivided into various attribute groups Aᵢ. In this case the orthogonalization of the attribute functions takes place in groups:

$$\begin{matrix}{f}_{α}^{ortho} ( h , w ) = \{ 1 if α fits the word sequence ( h , w ) and \\ \{ is also the attribute with the widest range \\ \{ in its attribute group {A}_{i} that fits \\ 0 otherwise\end{matrix}$$

The solution of the system of boundary conditions in accordance with formula (1), that is to say, the training object, is constituted by the so-termed maximum-entropy speech model MESM, which gives a suitable solution of the system of boundary conditions in the form of a suitable definition of the probability p(w|h), which reads as follows:

$${p}_{{λ}^{ortho}} ( w \vert h ) = \frac{1}{{Z}_{{λ}^{ortho}} ( h )} \cdot exp ( {\sum }_{α} {λ}_{α}^{ortho} \cdot {f}_{α}^{ortho} ( h , w ) ) \qquad ( 2 )$$

where the sum includes all the attributes α predetermined in the MESM; and where apart from the values listed above, the following magnitudes apply:

Z_{λortho} (h): a scaling factor;

λ^{ortho}: a set of all orthogonalized free parameters.

The free parameters λ^{ortho} are adapted so that the formula (2) represents a solution for the system of boundary conditions in accordance with formula (1). This adaptation normally takes place with the help of so-termed training algorithms. An example of such a training algorithm is the so-termed Generalized Iterative Scaling Algorithm (GIS), which is described for orthogonalized attribute functions in: R. Rosenfeld “A maximum-entropy approach to adaptive statistical language modelling”; Computer Speech and Language, 10: 187-228, 1996.

Once an individual or various iterative training steps have been executed in the training algorithm, a control can be made in each case on how well the free parameter λ^{ortho} has now been set by the training algorithm. This normally takes place in that the λ^{ortho} value set by the training is used in accordance with the following formula (3) as a parameter for the calculation of an approximate boundary value

$${M}_{α}^{ortho}$$

for the desired boundary value

$${M}_{α}^{ortho} :$$

$${M}_{α}^{ortho} = {\sum }_{( h , w )} \frac{N ( h )}{N} \cdot {p}_{{}_{{}^{{λ}^{ortho}}}} ( w \vert h ) \cdot {f}_{α}^{ortho} ( h , w ) \qquad ( 3 )$$

with the magnitudes listed above.

A comparison of the calculated approximate boundary values

$${M}_{α}^{ortho}$$

with the desired boundary values

$${m}_{α}^{ortho}$$

allows a statement to be made about the quality of the setting found for the free parameters

$${λ}_{α}^{ortho} .$$

In the calculation of the approximate boundary value

$${M}_{α}^{ortho}$$

in accordance with formula (3) for individual attributes α the case may arise that

$${M}_{α}^{ortho} = 0.$$

This case may arise if for the attribute α in the MESM attributes β with a wider range exist, which include the attribute α or in particular end with this. In that way the attribute α for certain word sequences (h, w) is blocked by the attribute β with the wider range in the sense that

$${f}_{α}^{ortho} ( h , w ) = 0.$$

If this is the case for all the unsolved (h, w) in formula (3), then in accordance with (1) the desired orthogonalized boundary value

$${m}_{α}^{ortho}$$

is also=0. This situation may be summarized by the formula

$${f}_{α}^{ortho} ( h , w ) = 0 for all ( h , w ) ∈ {D}_{c} \qquad ( 4 )$$

with

D_{c}={(h, w)|N(h)>0,wεV}

where

D_{c}: represents a restricted definition range for the probability function p_{λ}(h|w), where all words w from a vocabulary V of the MESM are freely selectable and only so-termed seen histories h can arise, where the seen histories are those that occur at least once in the training corpus of the MESM, that is for which N(h)>0.

If it is found that for an attribute α whose orthogonalized approximate boundary value calculated in accordance with formula (3)

$${M}_{α}^{ortho} = 0 ,$$

then it can be concluded that the associated free parameter

$${λ}_{α}^{ortho}$$

is defined with a number of possible interpretations or unclearly; the execution of the training algorithm was then unsuccessful for this parameter

$${λ}_{α}^{ortho}$$

for the attribute α; the parameter

$${λ}_{α}^{ortho} .$$

can then not be suitably set with the help of the normal training algorithm.

A free parameter

$${λ}_{α}^{ortho}$$

that has a number of possible interpretations has the disadvantage that the conditional probability p_{λ}(h|w) calculated on the basis of this in accordance with formula (2), with which a given word w follows an (unseen) history h, is defined with a number of possible interpretations or not at all. So the overall forecasting accuracy and efficiency of the corresponding speech model drops, and thus of a speech recognition system that works on the basis of the MESM.

Starting from this state of the art it is an object of the present invention to provide a speech recognition system, a training device and a method of setting a free parameter

$${λ}_{α}^{ortho}$$

of an attribute a in a maximum-entropy speech model MESM for the cases where a previous attempt at setting was unsuccessful with the help of a training algorithm.

This object is achieved as claimed in patent claim 1 by a method of setting a free orthogonalized parameter

$${λ}_{α}^{ortho}$$

of an attribute α in a maximum-entropy speech model MESM, if this free parameter could not be set with the help of a training algorithm that has been executed previously, where the attribute α belongs to an attribute group Aᵢ from a total of i=1 . . . n attribute groups in the MESM, comprising the following steps:

a) Replacing a desired orthogonalized boundary value

$${m}_{α}^{ortho}$$

for the attribute α with a modified desired orthogonalized boundary value

$${m}_{α}^{ortho , mod}$$

with:

$${m}_{α}^{ortho , mod} = {\sum }_{β ∈ {A}_{j}} {m}_{β}^{ortho}$$

where

βεAᵢ: represents all the attributes β ε Aᵢ that have a wider range than the attribute α, which end in the attribute α; and

$${m}_{β}^{ortho} :$$

represents the desired orthogonalized boundary values for the attributes β;

b) Calculating an expression ‘denominator_{α}’ according to:

$${denominator}_{α} = {\sum }_{β ∈ Ai} exp ( - {λ}_{β}^{ortho} ) \cdot {M}_{β}^{ortho} ,$$

where

βεAᵢ: represents all the attributes β ε Aᵢ that have a wider range than the attribute α, which end in the attribute α;

$${λ}_{β}^{ortho} :$$

represents the free orthogonalized parameter of the MESM for attribute β; and

$${M}_{β}^{ortho} :$$

represents the approximate boundary value for the desired orthogonalized boundary value

$${M}_{β}^{ortho}$$

for the attribute β;

and

c) Calculating the free orthogonalized parameter

$${λ}_{α}^{ortho}$$

according to

$${λ}_{α}^{ortho} = log ( \frac{{m}_{α}^{ortho , mod}}{{Nenner}_{α}} )$$

The thus calculated value for the free parameter

$${λ}_{α}^{ortho}$$

for the attribute α has only one interpretation, i.e. it is no longer ambiguous. It is adapted such that it approximates well the associated boundary value

$${m}_{α}^{ortho , mod}$$

for a restricted problem, i.e. for a reduced number of attributes within the MESM, which no longer have attributes β which have a wider range than the attribute α.

It is advantageous to use the orthogonalized free parameter

$${λ}_{α}^{ortho}$$

calculated with the help of the method in accordance with the invention for the calculation of a probability function

$${p}_{α}^{ortho} ( w \vert h )$$

in accordance with formula (2), because this is better adapted to the text statistics on which the training object is based.

Further advantageous method steps are the subject of the dependent claims.

The object in accordance with the invention is further achieved by a training device for training a speech recognition system as well as by a speech recognition system that has such a training device. The advantages of these devices correspond to the advantages as they have been mentioned above for the method.

A comprehensive description follows of a preferred example of embodiment of the invention with reference to the attached Figure, with this showing a speech recognition system in accordance with the present invention.

The method in accordance with the invention comprises essentially two steps, that can be summarized as follows:

i) Selection of all those attributes a which are blocked in the training by attributes β which have a wider range for all (h, w)ε D_{c} within the meaning of the above definition.

ii) Simulation for all these attributes of an application in which the attribute α is used and execution then of an adaptation of

$${λ}_{α}^{ortho} .$$

Use in these simulated applications not of the original, but of the modified, secondary conditions to fix the boundary conditions of the speech model.

The first step of the method is executed in that all those attributes are identified whose desired orthogonalized boundary values

$${m}_{α}^{ortho}$$

and whose approximate boundary values

$${M}_{α}^{ortho}$$

disappear or are equal to 0.

The second step of the method comprises a number of sub-steps, where generally a generalization is made of seen histories, that is, those histories that are contained in a training corpus MESM, and unseen histories which are not contained in the training corpus. The individual method steps are explained in the following with the example of a three-digit group attribute α=(y,z,w) in a word-based four-digit MESM.

1. For each seen history h=(x,y,z) the trigram attribute α=(y,z,w) is blocked by a quadgram attribute β=(x,y,z,w); here “blocked” means that

$${{f}_{α}^{ortho} ( h , w )}_{α}^{rtho} = 0 ,$$

because the attributes α and β fit the word sequence (h, w) and because β has a greater range than α. The expression

$$\frac{N ( h )}{N} \cdot p ( w \vert h )$$

therefore makes a contribution to the approximate boundary value

$${M}_{β}^{ortho}$$

in accordance with formula (3) for the attribute β.

2. For an unseen history h′=(x′,y,z) as a rule no quadgram attribute (x′,y,z,w) is defined and therefore α is in this case not blocked. If the training corpus were big enough to contain the history h′, then the term

$$\frac{N ( {h}^{′} )}{N} \cdot p ( w \vert {h}^{′} )$$

which is dependent on the free parameter

$${λ}_{α}^{ortho} ,$$

would be contained in the secondary conditions, that is to say, that it would be contained in the approximate boundary value

$${M}_{β}^{ortho}$$

This is not the case, however.

3. In order to simulate a situation where the trigram α is not blocked and in which the parameter

$${λ}_{α}^{ortho}$$

actually makes a contribution towards calculating the conditional probability of a p(w|h), the following notional experiment is carried out, where “ortho, mod” designates modified orthogonalized magnitudes:

For each seen history h=(x,y,z) in the training corpus the blocking quadgram attribute β=(x,y,z,w) is removed. Each of these histories h then takes over the function of h′in sub-item 2.

As desired, the modified probability p^{mod}(w|h) then depends on the orthogonalized free parameter

$${λ}_{α}^{ortho} ,$$

but not on the free parameter

$${λ}_{α}^{ortho} .$$

The attribute function associated with the attribute α then changes from

$${f}_{α}^{ortho} = 0$$

(for an unrestricted definition range) to

$${f}_{α}^{ortho , mod} = {\sum }_{β} {f}_{β}^{ortho} \neq 0$$

because all blocking quadgram βs have been removed beforehand.

The expressions

$$\frac{N ( h )}{N} \cdot {p}^{mod} ( w \vert h )$$

then make a contribution to the modified orthogonalized approximate boundary value

$${M}_{α}^{ortho , mod}$$

instead of to the approximate boundary value

$${M}_{β}^{ortho} .$$

The set of secondary conditions is modified:

a) All secondary conditions associated with the removed quadgram attributes are omitted.

b) The secondary condition associated with the trigram considered is based on the modified probability and the modified attribute functions.

As a consequence of this both sides of the formula (2) change:

The left side changes from

$${M}_{α}^{ortho} = 0 to {M}_{α}^{ortho , mod} .$$

The right side changes from

$${m}_{α}^{ortho} = 0 to {m}_{α}^{ortho , mod} = {\sum }_{β} {m}_{β}^{ortho}$$

because all blocking quadgrams βs have been removed.

4. It is now assumed that the set of all seen histories h=(x,y,z) together with the changes referred to corresponds to the set of unseen histories h′ and the applications of

$${λ}_{α}^{ortho} .$$

The parameter

$${λ}_{α}^{ortho}$$

is now adapted or set such that the secondary condition assigned to it is approximately met.

5. In order to actually perform the notional experiment, the dependency of the orthogonalized approximate boundary condition

$${M}_{α}^{ortho , mod}$$

of the free parameter

$${λ}_{α}^{ortho}$$

must be analyzed:

Initially the original probabilities are compared with the modified ones (as previously: h=(x,y,z), α=(y,z,w) and β=(x,y,z,w):

p(w|h)=Z⁻¹(h)exp(λ_{β}^{ortho}) (5)

p^{mod}(w|h)=(Z^{mod}(h))⁻¹exp(λ_{α}^{ortho} ) (6)

with the following normalizations:

$$Z ( h ) = exp ( {λ}_{β}^{ortho} ) + {\sum }_{v \neq w} exp ( {λ}_{( … , v )}^{ortho} ) \qquad ( 7 )$$

$${Z}^{mod} ( h ) = exp ( {λ}_{α}^{ortho} ) + {\sum }_{v \neq w} exp ( {λ}_{( … , v )}^{ortho} ) \qquad ( 8 )$$

where the designation ( . . . , v) designates the most extensive attributes that fit the word sequence (h, v).

Assuming that the free parameter

$${λ}_{α}^{ortho}$$

lies close to the free parameter

$${λ}_{α}^{ortho}$$

or that both

$$exp ( {λ}_{α}^{ortho} )$$

and exp

$$exp ( {λ}_{α}^{ortho} )$$

are significantly smaller than Σ_{v≠w}exp ( . . . ), the modified probability p^{mod} can be calculated as follows:

$$\begin{matrix}{p}^{mod} ( w \vert h ) = {( {Z}^{mod} ( h ) )}^{- 1} exp ( {λ}_{α}^{ortho} ) \\ \approx {Z}^{- 1} ( h ) exp ( {λ}_{α}^{ortho} ) \\ = exp ( {λ}_{α}^{ortho} - {λ}_{β}^{ortho} ) \cdot p ( w \vert h )\end{matrix} \qquad ( 9 )$$

When the approximation is used in accordance with formula 9, the modified orthogonalized approximate boundary value

$${M}_{α}^{ortho , mod}$$

can easily be derived from the original boundary values

$${M}_{β}^{ortho} .$$

More importantly, however, is that it is approximately proportional to the free parameter

$${λ}_{α}^{ortho} ,$$

as shown in the following:

$$\begin{matrix}{M}_{( y , z , w )}^{ortho , mod} = {\sum }_{( h , w )} \frac{N ( h )}{N} \cdot {p}^{mod} ( w \vert h ) \cdot {f}_{( y , z , w )}^{ortho , mod} ( h , w ) \\ = {\sum }_{x} \frac{N ( x , y , z )}{N} \cdot {p}^{ortho , mod} ( w \vert x , y , z ) \\ \approx {\sum }_{x} \frac{N ( x , y , z )}{N} \cdot [ exp ( {λ}_{( y , z , w )}^{ortho} - {λ}_{( x , y , z , w )}^{ortho} ) \cdot p ( w \vert x , y , z ) ] \\ = exp ( {λ}_{( y , z , w )}^{ortho} ) \cdot {\sum }_{x} exp ( - {λ}_{( x , y , z , w )}^{ortho} ) \cdot [ \frac{N ( x , y , z )}{N} \cdot p ( w \vert x , y , z ) ] \\ = exp ( {λ}_{( y , z , w )}^{ortho} ) \cdot {\sum }_{x} exp ( - {λ}_{( x , y , z , w )}^{ortho} ) \cdot {M}_{( x , y , z , w )}^{ortho}\end{matrix} \qquad ( 10 )$$

And, finally, equating the orthogonalized approximate boundary value

$${M}_{α}^{ortho , mod}$$

to the modified orthogonalized desired boundary value

$${m}_{α}^{ortho , mod}$$

leads to the desired and sought after adaptation of the orthogonalized parameter

$${λ}_{α}^{ortho} ,$$

which is then calculated as follows:

$$exp ( {λ}_{( y , z , w )}^{ortho} ) = \frac{{m}_{( y , z , w )}^{ortho , mod}}{{\sum }_{x} exp ( - {λ}_{( x , y , z , w )}^{ortho} ) \cdot {M}_{x , y , z , w )}^{ortho}} \qquad ( 11 )$$

Such a setting of the free parameter

$${λ}_{α}^{ortho}$$

that used to have a number of possible interpretations allows a calculation of the probability p_{λ} in a training device or a speech recognition system, that better generalizes from the seen histories h to unseen histories h′.

The FIGURE accompanying the specification shows such a training device 10, which usually serves for training a speech recognition system that uses an MESM for the speech recognition. The training device 10 normally comprises a training unit 12 for training of free parameters

$${λ}_{α}^{ortho}$$

of the MESM with the help of a training algorithm, such as the GIS training algorithm. As shown in the introduction to the specification, the training of the free parameters

$${λ}_{α}^{ortho}$$

is not, however, always successful and it may thus happen that individual free parameters

$${λ}_{α}^{ortho}$$

of the MESM even after passing through the training algorithm still have not been adapted in the desired manner. They are particularly those attributes for which the orthogonalized approximate boundary values

$${M}_{α}^{ortho}$$

calculated in accordance with formula (3) give the value of 0.

In order to set also these non-adapted free parameters that have a number of possible interpretations to a suitable value, the training device 10 has an optimization unit 14, which receives the parameters that have a number of possible interpretations from the training unit 12 and optimizes them according to the method in accordance with the invention described previously.

Advantageously, but not necessarily, such a training device 10 forms part of a speech recognition system 100, that carries out speech recognition based on the MESM.

1. A method of setting a free orthogonalized parameter
$${λ}_{α}^{ortho}$$
ps of an attribute α in a maximum-entropy speech model MESM, if this free parameter could not be set with the help of a training algorithm executed previously, where the attribute a belongs to an attribute group Aᵢ from a total of i=1 . . . n attribute groups in the MESM, the method comprising the following steps:
a) Replacing a desired orthogonalized boundary value
$${m}_{α}^{ortho}$$
for the attribute a with a modified desired orthogonalized boundary value
$${m}_{α}^{ortho , mod}$$
with:
$${m}_{α}^{ortho , mod} = {\sum }_{β = {A}_{i}} {m}_{β}^{ortho}$$
where
βεAᵢ: represents all the attributes β ε Aᵢ that have a wider range than the attribute α, which end in the attribute α; and
$${m}_{β}^{ortho} :$$
represents the desired orthogonalized boundary values for the attributes β;
b) Calculating an expression ‘denominator_{α}’ according to: denominatorα
$${\sum }_{β ∈ {A}_{i}} exp ( - {λ}_{β}^{ortho} ) \cdot {M}_{β}^{ortho}$$
where
βεAᵢ: represents all the attributes β ε Aᵢ that have a wider range than the attribute α, which end in the attribute α;
$${λ}_{β}^{ortho} :$$
represents the free orthogonalized parameter of the MESM for attribute β; and
$${M}_{β}^{ortho} :$$
represents the approximate boundary value for the desired orthogonalized boundary value for the attribute β;
and
c) Calculating the free orthogonalized parameter
$${λ}_{β}^{ortho}$$
according to
$${λ}_{α}^{ortho} = log ( \frac{{m}_{α}^{ortho , mod}}{{denominator}_{α}} )$$

2. A method as claimed in claim 1, characterized in that the approximate boundary value
$${M}_{β}^{ortho}$$
in step 1b) is calculated according to:
$${M}_{β}^{ortho} = {\sum }_{( h , w )} \frac{N ( h )}{N} \cdot {p}_{{λ}^{ortho}} ( w \vert h ) \cdot {f}_{β}^{ortho} ( h , w )$$
where:
N: describes the number of words in a training corpus of the speech model;
$$\frac{N ( h )}{N} \text{:}$$
the relative frequency of the word sequence h (history) in the training corpus;
and
P_{λortho} (w|h): the probability with which a new given word w follows the previous history h;
λ^{ortho}: free orthogonalized parameters for all attributes α, β . . . ;
$${f}_{β}^{ortho} :$$
the orthogonalized attribute function for the attribute β.

3. The use of the orthogonalized free parameter
$${λ}_{α}^{ortho}$$
calculated as claimed in method claim 1 for the calculation of a probability function p_{λortho} (w|h) according to:
$${p}_{{λ}^{ortho}} ( w \vert h ) = \frac{1}{{Z}_{{λ}^{ortho}} ( h )} exp ( {\sum }_{α} {λ}_{α}^{ortho} \cdot {f}_{α}^{ortho} ( h , w ) ) .$$

4. A training device (10) for training a speech recognition system (100) which system uses a maximum-entropy speech model MESM for speech recognition, the training device comprising a training unit (12) for training free parameters
$${λ}_{α}^{ortho}$$
of the MESM with the help of a training algorithm; characterized by an optimization unit (14) for optimizing those free parameters
$${λ}_{α}^{ortho}$$
from the number of parameters
$${λ}_{α}^{ortho}$$
which could not be set by training in the training unit (12), in accordance with the method as claimed in claim 1.

5. A speech recognition system (100) which carries out speech recognition on the basis of the MESM, comprising a training device (10) as claimed in claim 5.
